(19) United States
(12) Patent Application Publication
(10) Pub. No.: US 2022/0053801 A1
(43) Pub. Date: Feb. 24, 2022

(54) COMPOSITION

(71) Applicant: SUNTORY HOLDINGS LIMITED, Osaka (JP)

(72) Inventors: Akinori ITOYAMA, Kanagawa (JP); Yoji ASAMI, Kanagawa (JP); Akiko FUJIE, Kanagawa (JP); Shigeru SARADA, Kanagawa (JP)

(73) Assignee: SUNTORY HOLDINGS LIMITED, Osaka (JP)

(21) Appl. No.: 17/298,754

(22) PCT Filed: Dec. 6, 2019
(86) PCT No.: PCT/JP2019/048838

§ 371 Date: Jun. 1, 2021

(30) Foreign Application Priority Data
Dec. 7, 2018 (JP) 2018-230147

(51) Int. Cl. A23L 2/60; A23L 2/54

(52) U.S. Cl. CPC A23L 2/60; A23V 2002/00; A23L 2/54

(57) ABSTRACT

The present invention relates to beverage compositions wherein the sweetness linger of rebaudioside M (Reb M) is reduced or minimized. Beverage composition comprising Reb M and sucrose and/or HFCS are provided. Also provided herein are methods of reducing the sweetness linger of Reb M in beverage compositions.

### FIELD OF THE INVENTION

The present invention relates to sweetened beverage compositions comprising the steviol glycoside rebaudioside M (Reb M) in combination with sucrose or high fructose corn syrup. The present invention also relates to methods to reduce the sweetness linger effect of Reb M.

### BACKGROUND TO THE INVENTION

Sweeteners are used in beverages to impart a pleasant sweet taste. However, the use of caloric sweeteners such as sucrose, glucose, fructose etc. has been linked to a wide array of health concerns. In particular obesity, diabetes, high cholesterol, tooth decay etc. have been linked to high sugar consumption.

Therefore, natural high intensity low-caloric sweeteners are a desirable alternative to sugars. These products possess a sweetness level many times that of sucrose and their use can substantially reduce the number of calories present in a beverage or foodstuff. However, although these products produce a very sweet taste they can have negative taste aspect such as bitterness lingering etc., which consumers may dislike. As such there has been much research into identifying high intensity sweeteners with the most desirable taste profile.

One of compounds that has been investigated for this reason is the steviol glycosides. These compounds are found in the leaves of the plant Stevia rebaudiana. This plant is a perennial shrub of the Asteraceae (Compositae) family which is native to certain regions of South America. The leaves of the plant have been used for hundreds of years to sweeten tea and in traditional medicines. Crude stevia extracts were first commercialised as sweeteners in Japan in the early 1970s and the stevia plant is commercially cultivated in parts of Asia and South America.

To date a number of different sweet tasting steviol glycosides have been identified and characterised. The compounds all contain a common aglycone steviol (ent-13-hydroxykaur-16-en-19-oic acid) shown in FIG. 1. The steviol glycosides then differ in the number and type of sugars which are attached at positions C13 (R²) and C19 (R¹).

| | | | Sweetness |
|---|---|---|---|
| | R groups on steviol | | potency (relative |
| Compound | R¹ | R² | to sucrose) |
| Rebaudioside A | β-glc- | (β-glc-)₂-β-glc- | 200-300 |
| Rebaudioside B | H | (β-glc-)₂- β-glc- | 150 |
| Rebaudioside C | β-glc- | (β-glc, α-rha)-β- | 30 |
| | | glc- | |
| Rebaudioside D | β-glc- β-glc- | (β-glc-)₂-β-glc- | 221 |
| Rebaudioside E | β-glc- β-glc- | β-glc- β-glc- | 174 |
| Rebaudioside F | β-glc- | (β-glc, β-xyl)- β- | 200 |
| | | glc- | |
| Rebaudioside M | (β-glc-)₂-β-glc- | (β-glc-)₂- β-glc- | 200-250 |
| Rubusoside | β-glc- | β-glc- | 114 |
| Steviolbioside | H | β-glc- β-glc- | 90 |
| Stevioside | β-glc- | β-glc-β-glc- | 150-250 |

### SUMMARY OF THE INVENTION

Out of the rebaudiosides, the minor rebaudioside M (Reb M) has recently been identified as a high potency sweetener with a clean sweet taste with minimal bitter aftertaste. However, it has been identified that when beverages containing Reb M are consumed the sweetness intensity lingers overtime more than conventional sweeteners. Further, it has been observed that beverages comprising carbohydrate sweeteners or artificial sweeteners increase in sweetness over multiple sips. However, the sweetness intensity of Reb M does not increase over multiple sips, it remains the same. These characteristics can be unusual or unpleasant to the consumer and so there is a need to find compositions where these features are reduced or masked.

The present invention aims to provide beverage compositions and methods which reduce the negative organoleptic properties of Reb M. In particular these compositions and methods aimed to reduce the residual sweetness intensity that remains after beverage containing Reb M is consumed.

The data presented herein assessed a number of other sweeteners to determine their ability to reduce the sweetness linger of Reb M. The sweeteners that were investigated were sucrose, HFCS and sucralose. Surprisingly only the addition of sucrose and HFCS resulted in a reduction in the sweetness linger of the Reb M beverages. The addition of sucralose resulted in either no effect on the sweetness linger or at certain concentrations increased the sweetness linger. It was surprisingly found that a small concentration of sucrose could effectively reduce the sweetness linger of Reb M. It was observed that increasing the concentration of sucrose did not significantly improve the reduction in sweetness linger. Therefore, this has the additional benefit that the combination of Reb M and sucrose could be used in reduced calorie beverages. Only a relatively small amount of sucrose is required to achieve the desired effect, therefore the caloric impact of the beverage is not significantly increased compared to using Reb M as a sweetener on its own. For example the present data shows that 2% sucrose can significantly mask the sweetness linger of Reb M, whereas in a standard soft drink sucrose is commonly used at around 10-12%. Therefore, a beverage of the present invention would have a reduced sweetness linger whilst containing significantly less calories than would be present in a beverage sweetened using sucrose alone. Further, the data presented herein also shows that HFCS can be used to effectively mask the sweetness linger of Reb M. The reduction of the sweetness linger minimises the negative taste aspects of the low calorie sweetener and results in a beverage with a more pleasing taste.

A first aspect of the invention is a beverage composition comprising Reb M in a concentration from 100 ppm to 600 ppm and sucrose in an amount from 0.5 to 5 wt % based on total weight of the beverage composition, wherein the Brix ratio of Reb M:sucrose is from 10:1 to 1:1.

A second aspect of the invention is a beverage composition comprising Reb M in a concentration from 100 ppm to 600 ppm and HFCS in an amount from 2 to 8 wt % based on total weight of the beverage composition, wherein the Brix ratio of Reb M:HFCS is from 10:1 to 1:1.

A third aspect of the invention is a method of reducing the sweetness linger of Reb M in a beverage composition, wherein the method comprises adding sucrose to the beverage in an amount from 0.5 to 5 wt % based on total weight of the beverage composition, wherein the Brix ratio of Reb M:sucrose is from 10:1 to 1:1.

A fourth aspect of the invention is a method of reducing the sweetness linger of Reb M in a beverage composition, wherein the method comprises adding HFCS to the beverage in an amount from 2 to 8 wt % based on total weight of the beverage composition, wherein the Brix ratio of Reb M:HFCS is from 10:1 to 1:1.

### BRIEF DESCRIPTION OF THE DRAWINGS

FIG. 1 shows the core aglycone steviol moiety that is common between all rebaudiosides. The rebaudiosides vary in terms of the sugar moieties that are attached at C13 and C19.

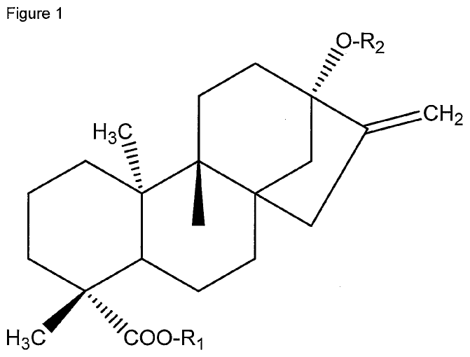

FIG. 2 shows the structure of rebaudioside M (Reb M).

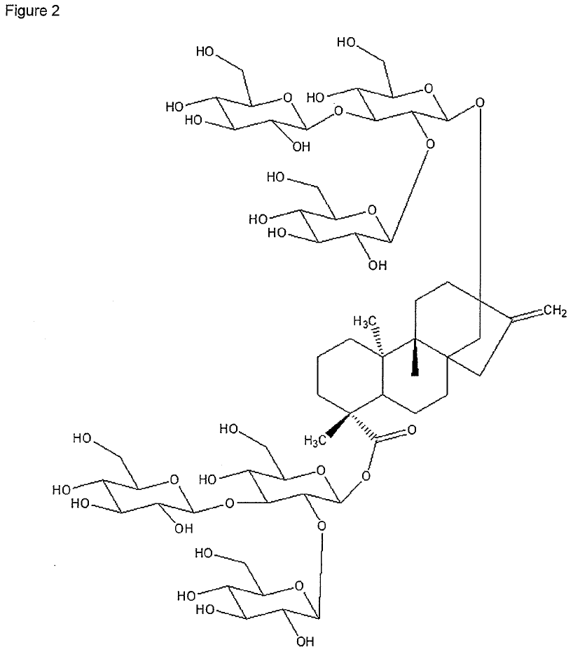

FIG. 3 shows the sweetness level of a 0.05 wt % Reb M beverage over time, as assessed by a trained sensory panel. This beverage has a Brix of 10° Bx

FIG. 4 shows the sweetness level of a 0.04 wt % Reb M+2 wt % sucrose beverage (a 4:1 Brix ratio of Reb M:sucrose) over time, as assessed by a trained sensory panel.

FIG. 5 shows the sweetness level of a 0.025 wt % Reb M+5 wt % sucrose beverage (a 1:1 Brix ratio of Reb M:sucrose) over time, as assessed by a trained sensory panel.

FIG. 6 shows the sweetness level of a 0.04 wt % Reb M+0.005 wt % sucralose beverage (a 4:1 Brix ratio of Reb M:sucralose) overtime, as assessed by a trained sensory panel.

FIG. 7 shows the sweetness level of a 0.03 wt % Reb M+0.01 wt % sucralose beverage (a 1.5:1 Brix ratio of Reb M:sucralose) over time, as assessed by a trained sensory panel.

FIG. 8 shows the sweetness level of a 0.02 wt % Reb M+0.015 wt % sucralose beverage (a 1:1.5 Brix ratio of Reb M:sucralose) over time, as assessed by a trained sensory panel.

FIG. 9 shows the sweetness level of a 0.01% Reb M+0.02 wt % sucralose beverage (a 1:4 Brix ratio of Reb M:sucralose) overtime, as assessed by a trained sensory panel.

FIG. 10 shows the sweetness level of a 0.04 wt % Reb M+2.65 wt % HFCS beverage (a 4:1 Brix ratio of Reb M:HFCS) over time, as assessed by a trained sensory panel.

FIG. 11 shows the sweetness level of a 0.025 wt % Reb M+6.62 wt % HFCS beverage (a 1:1 Brix ratio of Reb M:HFCS) over time, as assessed by a trained sensory panel.

### DETAILED DESCRIPTION

The present invention provides beverage compositions comprising Reb M wherein the sweetness linger effect of Reb M is reduced. As used herein the term “sweetness linger” refers to a residual sweet taste that remains after drinking a beverage product. This residual sweetness is found commonly in beverages which have been sweetened with rebaudiosides such as Reb M.

A first aspect of the invention is a beverage composition comprising Reb M in a concentration from 100 ppm to 600 ppm and sucrose in an amount from 0.5 to 5 wt %, wherein the Brix ratio of Reb M:sucrose is from 10:1 to 1:1. The beverage may comprise Reb M in a concentration from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm and sucrose in an amount from 0.5 to 5%, 0.5 to 4.5%, 0.5 to 4%, 0.5 to 3.5%, 0.5 to 3%, 0.5 to 2.5%, 0.5 to 2.0%, 0.5 to 1.5%, 0.5 to 1%, 1 to 5%, 1 to 4.5%, 1 to 4%, 1 to 3.5%, 1 to 3%, 1 to 2.5%, 1 to 2.0%, 1 to 1.5, 1.5 to 5%, 1.5 to 4.5%, 1.5 to 4%, 1.5 to 3.5%, 1.5 to 3%, 1.5 to 2.5%, 1.5 to 2.0%, 2 to 5%, 2 to 4.5%, 2 to 4%, 2 to 3.5%, 2 to 3%, 2 to 2.5%, 2.5 to 5%, 2.5 to 4.5%, 2.5 to 4%, 2.5 to 3.5%, 2.5 to 3%, 3 to 5%, 3 to 4.5%, 3 to 4%, 3 to 3.5%, 3.5 to 5%, 3.5 to 4.5%, 3.5 to 4%, 4 to 5%, 4 to 4.5%, or 4.5 to 5%. All ppms and percentages are by weight.

In an embodiment the beverage composition comprises sucrose in an amount from 0.5 to 3 wt %, and Reb M in an amount from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm.

In an embodiment the beverage composition comprises sucrose in an amount from 1.5 to 2.5 wt %, and Reb M in an amount from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm.

In an embodiment of the first aspect the Brix ratio of Reb M:sucrose is from 10:1 to 1:1, 9:1 to 1:1, 8:1 to 1:1, 7:1 to 1:1, 6:1 to 1:1, 5:1 to 1:1, 4:1 to 1:1, 3:1 to 1:1, 2:1 to 1:1, 10:1 to 2:1, 9:1 to 2:1, 8:1 to 2:1, 7:1 to 2:1, 6:1 to 2:1, 5:1 to 2:1, 4:1 to 2:1, 3:1 to 2:1, 10:1 to 3:1, 9:1 to 3:1, 8:1 to 3:1, 7:1 to 3:1, 6:1 to 3:1, 5:1 to 3:1, 6:1 to 3:1, 5:1 to 3:1, or 4:1 to 3:1.

The ratios disclosed herein are presented in terms of Brix equivalence. The amount of sucrose in a reference solution may be described in degrees Brix (° Bx). One degree Brix is 1 gram of sucrose in 100 grams of aqueous solution and represents the strength of the solution as percentage by weight (% wt). A 500 ppm (0.05 wt %) Reb M solution is equivalent to 10° Bx, a 13.3% HFCS solution is equivalent to 10° Bx and a 10% sucrose solution has a Brix of 10° Bx.

In an embodiment the beverage composition according to the first aspect comprises Reb M in a concentration from 200 ppm to 500 ppm, 250 ppm to 500 ppm, or 300 ppm to 500 ppm, and sucrose in an amount from 0.5 to 3%, 0.5 to 2.5%, 0.5 to 2% wherein the Brix ratio of Reb M:sucrose is from 6:1 to 1:1, 5:1 to 2:1, or 4:1 to 3:1. In a preferred embodiment the Brix ratio of Reb M:sucrose is about 4:1. All ppms and percentages are by weight.

A second aspect of the invention is a beverage composition comprising Reb M in a concentration from 100 ppm to 600 ppm and HFCS in an amount from 2 to 8 wt %, wherein the ratio of Reb M:HFCS is from 10:1 to 1:1. The beverage may comprise Reb M in a concentration from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm and HFCS in an amount from 2 to 8%, 2 to 7.5%, 2 to 7%, 2 to 6.5%, 2 to 6%, 2 to 5.5%, 2 to 5%, 2 to 4.5%, 2 to 4%, 2 to 3.5%, 2 to 3%, 2 to 2.5%, 2.25 to 8%, 2.25 to 7.5%, 2.25 to 7%, 2.25 to 6.5%, 2.25 to 6%, 2.25 to 5.5%, 2.25 to 5%, 2.25 to 4.5%, 2.25 to 4%, 2.25 to 3.5%, 2.25 to 3%, 2.25 to 2.5%, 2.5 to 8%, 2.5 to 7.5%, 2.5 to 7%, 2.5 to 6.5%, 2.5 to 6%, 2.5 to 5.5%, 2.5 to 5%, 2.5 to 4.5%, 2.5 to 4%, 2.5 to 3.5%, 2.5 to 3%, 3 to 8%, 3 to 7.5%, 3 to 7%, 3 to 6.5%, 3 to 6%, 3 to 5.5%, 3 to 5%, 3 to 4.5%, 3 to 4%, 3 to 3.5%, 3.5 to 8%, 3.5 to 7.5%, 3.5 to 7%, 3.5 to 6.5%, 3.5 to 6%, 3.5 to 5.5%, 3.5 to 5%, 3.5 to 4.5%, 3.5 to 4%, 4 to 8%, 4 to 7.5%, 4 to 7%, 4 to 6.5%, 4 to 6%, 4 to 5.5%, 4 to 5%, 4 to 4.5%, 4.5 to 8%, 4.5 to 7.5%, 4.5 to 7%, 4.5 to 6.5%, 4.5 to 6%, 4.5 to 5.5%, 4.5 to 5%, 5 to 8%, 5 to 7.5%, 5 to 7%, 5 to 6.5%, 5 to 6%, 5 to 5.5%, 5.5 to 8%, 5.5 to 7.5%, 5.5 to 7%, 5.5 to 6.5%, 5.5 to 6%, 6 to 8%, 6 to 7.5%, 6 to 7%, 6 to 6.5%, 6.5 to 8%, 6.5 to 7.5%, 6.5 to 7%, 6.62 to 8%, 6.62 to 7.5%, 6.62 to 7%, 7 to 8%, or 7 to 7.5%. All ppms and percentages are by weight.

In an embodiment the beverage composition comprises HFCS in an amount from 3 to 8 wt %, and Reb M in an amount from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm.

In an embodiment the beverage comprises HFCS in an amount from 4 to 8 wt %, and Reb M in an amount from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm.

In an embodiment the beverage composition comprises HFCS in an amount from to 8 wt %, and Reb M in an amount from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm.

In an embodiment of the second aspect the Brix ratio of Reb M:HFCS is from 10:1 to 1:1, 9:1 to 1:1, 8:1 to 1:1, 7:1 to 1:1, 6:1 to 1:1, 5:1 to 1:1, 4:1 to 1:1, 3:1 to 1:1, 2:1 to 1:1, 10:1 to 2:1, 9:1 to 2:1, 8:1 to 2:1, 7:1 to 2:1, 6:1 to 2:1, 5:1 to 2:1, 4:1 to 2:1, 3:1 to 2:1, 10:1 to 3:1, 9:1 to 3:1, 8:1 to 3:1, 7:1 to 3:1, 6:1 to 3:1, 5:1 to 3:1, 6:1 to 3:1, 5:1 to 3:1, or 4:1 to 3:1.

In an embodiment the beverage composition according to the second aspect comprises Reb M in a concentration from 200 ppm to 500 ppm, 250 ppm to 500 ppm, or 300 ppm to 500 ppm, and HFCS in an amount from 4 to 7%, 5 to 7%, 6 to 7% wherein the Brix ratio of Reb M:HFCS is from 6:1 to 1:1, 5:1 to 2:1, or 4:1 to 3:1. In a preferred embodiment the ratio of Reb M:HFCS is about 1:1. All ppms and percentages are by weight.

In an embodiment of the first or second aspects of the present invention the pH of the beverage composition is from pH 2 to 5, pH 2.2 to 5, pH 2.4 to 5, pH 2.6 to 5, pH 2.8 to 5, pH 3.0 to 5, pH 3.5 to 5, pH 2 to 4.5, pH 2.2 to 4.5, pH 2.4 to 4.5, pH 2.6 to 4.5, pH 2.8 to 4.5, pH 3 to 4.5, pH 3.5 to 4.5, pH 2 to 4, pH 2.2 to 4, pH 2.4 to 4, pH 2.6 to 4, pH 2.8 to 4, pH 3 to 4, pH 3.5 to 4, pH 2 to 3.5, pH 2.2 to 3.5, pH 2.4 to 3.5, pH 2.6 to 3.5, pH 2.8 to 3.5, pH 3.0 to 3.5. Preferably the pH is in the range from pH 2.5 to 3.5.

In beverage it is preferable that a buffer system is used. Suitable buffer systems of use in the present invention include, by way of example only, tartaric, fumaric, maleic, phosphoric, and acetic acids and salts. Preferred buffering systems include citric acid and phosphoric acid buffer systems. The most preferred buffer system is a citric acid buffer system preferably contains sodium citrate in combination with citric acid. Preferably there is about 0.1 to about 10 grams/litre of sodium citrate, and about 0.05 to about 5 grams/litre of citric acid. Typically suitable buffer systems include those capable of maintaining a pH in the range stated in the embodiments herein.

In an embodiment of the first and second aspects the beverage composition may be carbonated. As used herein a “carbonated beverage” is a beverage that contains carbon dioxide gas (CO₂). The presence of the CO₂ produces bubbles within the beverage.

In an embodiment of the first and second aspects the carbonated beverage may comprise carbon dioxide (CO₂) at a gas pressure from 1.0-3.5 kg/m³. Preferably the CO₂ is at a gas pressure from 1.5-3.0 kg/m³, more preferably the CO₂ is at a gas pressure from 2.0-3.0 kg/m³.

In another embodiment of the first and second aspects the carbonated beverage may comprise carbon dioxide (CO₂) at a gas pressure from 1.0-3.5 kgf/cm². Preferably the CO₂ is at a gas pressure from 1.5-3.0 kgf/cm², more preferably the CO₂ is at a gas pressure from 2.0-3.0 kgf/cm².

The beverage composition according to the first or second aspect of the present invention may comprise Reb M as the primary sweetening component. The beverage composition according to the first or second aspect of the present invention may comprise Reb M as the sole low caloric sweetener component. The beverage composition may also comprise other sweetening components such as other steviol sweeteners. Non-limiting examples of steviol sweeteners include Reb A, Reb B, Reb C, Reb D, Reb E, Reb F, Reb I, Reb H, Reb L, Reb K, Reb J, Reb M, Reb N, Reb O, dulcoside A, dulcoside B, stevioside, steviolbioside, rubusoside. Preferably, Reb M is the only steviol sweetening component in the beverage.

The beverage according to the first aspect may also comprise additional carbohydrate based sweeteners, non-limiting examples include fructose, glucose, erythritol, maltitol, lactitol, sorbitol, mannitol, xylitol, tagatose, trehalose, galactose, rhamnose, cyclodextrin, ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose, galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, maltooligosaccharides (maltotriose, maltotetraose, maltopentaose, maltohexaose, maltoheptaose), dextrins, lactulose, melibiose, raffinose, rhamnose, ribose, isomerized liquid sugars such as high fructose corn syrup (HFCS e.g., HFCS55, HFCS42, or HFCS90), coupling sugars, soybean oligosaccharides, glucose syrup and combinations thereof. D- or L-configurations can be used when applicable.

The beverage according to the second aspect may also comprise additional carbohydrate based sweeteners, non-limiting examples include sucrose, fructose, glucose, erythritol, maltitol, lactitol, sorbitol, mannitol, xylitol, tagatose, trehalose, galactose, rhamnose, cyclodextrin, ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose, galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, maltooligosaccharides (maltotriose, maltotetraose, maltopentaose, maltohexaose, maltoheptaose), dextrins, lactulose, melibiose, raffinose, rhamnose, ribose, coupling sugars, soybean oligosaccharides, glucose syrup and combinations thereof. D- or L-configurations can be used when applicable.

Additional sweetening components may be selected from natural high potency sweeteners such as mogroside IV, mogroside V, Luo Han Guo, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I.

Additional sweetening components may be synthetic sweeteners. As used herein, the phrase “synthetic sweetener” refers to any composition which is not found naturally in nature and characteristically has a sweetness potency greater than sucrose, fructose, or glucose, yet has less calories. Non-limiting examples of synthetic high-potency sweeteners suitable for embodiments of this disclosure include sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

Any of the additional sweetening components, either carbohydrate sweeteners, natural high potency sweeteners or synthetic sweeteners may be present in the beverage composition in a concentration from about 0.3 ppm to about 3,500 ppm.

The amount of sucrose in a reference solution may be described in degrees Brix (° Bx). One degree Brix is 1 gram of sucrose in 100 grams of aqueous solution and represents the strength of the solution as percentage by weight (% wt). In one embodiment of the first aspect of the invention, a beverage composition contains Reb M and sucrose in an amount effective to provide a total sweetness equivalent from about 0.5 to 15° Bx of sucrose when present in a sweetened composition, such as, for example, from about 5 to about 11 degrees Brix, from about 4 to about 7 degrees Brix, or about 5 degrees Brix. In another embodiment, Reb M and sucrose are present in an amount effective to provide sweetness equivalent to about 10° Bx.

In one embodiment of the second aspect of the invention, a beverage composition contains Reb M and HFCS in an amount effective to provide a total sweetness equivalent from about 0.5 to 15° Bx of sucrose when present in a sweetened composition, such as, for example, from about 5 to about 11 degrees Brix, from about 4 to about 7 degrees Brix, or about 5 degrees Brix. In another embodiment, Reb M and HFCS are present in an amount effective to provide sweetness equivalent to about 10° Bx.

In various embodiments of the present invention the total sweetness of the beverage composition is equivalent to 0.5 to 15 degrees Brix, 2 to 14 degrees Brix, 3 to 13 degrees Brix, 4 to 12 degrees Brix, 5 to 11 degrees Brix, 6 to 10 degrees Brix, or 9 to 10 degrees Brix. Most preferably the total sweetness of the beverage composition is equivalent to about 10 degrees Brix.

The term “about” as used herein indicates that a margin of +/−10% is applicable to the stated value.

In addition to Reb M and sucrose or HFCS, and optionally one or more additional sweetening components, the beverage composition can optionally include further additives, detailed herein below. In some embodiments, the sweetener composition contains additives such as, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, weighing agents, gums, antioxidants, colorants, flavonoids, alcohols, polymers and combinations thereof. In some embodiments, the additives act to improve the temporal and flavor profile of the sweetener to provide a beverage composition with excellent taste properties.

In a preferred embodiment the beverage may also comprise cinnamaldehyde, caffeine, caramel colouring and/or phosphoric acid

The beverage compositions which are suitable for the present invention include a ready-to-drink beverage, a beverage concentrate, a beverage syrup, or a powdered beverage. Suitable ready-to-drink beverages include carbonated and non-carbonated beverages. Carbonated beverages include, but are not limited to, enhanced sparkling beverages, cola, lemon-lime flavored sparkling beverage, orange flavored sparkling beverage, grape flavored sparkling beverage, strawberry flavored sparkling beverage, pineapple flavored sparkling beverage, ginger-ale, soft drinks and root beer. Non-carbonated beverages include, but are not limited to fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, milk beverages, coffee containing milk components, café au lait, milk tea, fruit milk beverages, beverages containing cereal extracts, smoothies and combinations thereof.

The beverages of the present invention may be a beverage composition concentrate. As used herein the term “beverage composition concentrate” also refers to “beverage syrup”. Beverage composition concentrates and beverage syrups are prepared with an initial volume of liquid (e.g. water) and the desired beverage ingredients. These products are more concentrated than a ready to drink beverage. A ready to drink beverage can be prepared from a concentrate or syrup by adding further volumes of liquid. A beverage concentrate may be from 3 to 15 fold more concentrated, or from 5 to 15 fold more concentrated, or from 8 to 12 fold more concentrated, or from 9 to 11 fold more concentrated than the ready-to-drink beverage.

In order produce a ready to drink beverage from the beverage composition concentrate additional liquid is required to dilute the concentrate. Suitable liquids include water, carbonated water deionized water, distilled water, reverse osmosis water, carbon-treated water, purified water, demineralized water. Wherein carbonated water is used the water may comprise CO₂ at a gas pressure from 1.0-3.5 kg/m³. Preferably the CO₂ is at a gas pressure from 1.5-3.0 kg/m³, more preferably the CO₂ is at a gas pressure from 2.0-3.0 kg/m³.

In another embodiment, wherein carbonated water is used the water may comprise CO₂ at a gas pressure from 1.0-3.5 kgf/cm². Preferably the CO₂ is at a gas pressure from 1.5-3.0 kgf/cm², more preferably the CO₂ is at a gas pressure from 2.0-3.0 kgf/cm².

In an embodiment of the first or second aspects of the invention the beverage is a low-calorie beverage composition or a reduced calorie beverage composition. A low-calorie beverage composition may have less than 75 kcal per 100 mL, less than 60 kcal per 100 mL, less than 50 kcal per 100 mL, less than 40 kcal per 100 mL, less than 30 kcal per 100 mL, less than 20 kcal per 100 mL. Wherein the beverage composition is a beverage composition concentrate, the ready-to-drink beverage composition that is produced upon diluting the concentrate may be a low calorie beverage.

The data presented herein demonstrates that it is possible to reduce the sweetness linger effect, which results from using Reb M in a beverage composition, by adding sucrose to the beverage composition. The resulting beverage, which has a combination of Reb M and sucrose, has a reduced sweetness linger when compared to a beverage comprising Reb M alone. As such a third aspect of the invention is a method of reducing the sweetness linger of Reb M in a beverage composition, wherein the method comprises adding sucrose to the beverage composition in an amount from 0.5 to 5%, wherein the Brix ratio of Reb M:sucrose is from 10:1 to 1:1.

An embodiment of the third aspect of the invention comprises preparing a beverage composition comprising Reb M at a concentration from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm and sucrose in an amount from 0.5 to 5%, 0.5 to 4.5%, 0.5 to 4%, 0.5 to 3.5%, 0.5 to 3%, 0.5 to 2.5%, 0.5 to 2.0%, 0.5 to 1.5%, 0.5 to 1%, 1 to 5%, 1 to 4.5%, 1 to 4%, 1 to 3.5%, 1 to 3%, 1 to 2.5%, 1 to 2.0%, 1 to 1.5, 1.5 to 5%, 1.5 to 4.5%, 1.5 to 4%, 1.5 to 3.5%, 1.5 to 3%, 1.5 to 2.5%, 1.5 to 2.0%, 2 to 5%, 2 to 4.5%, 2 to 4%, 2 to 3.5%, 2 to 3%, 2 to 2.5%, 2.5 to 5%, 2.5 to 4.5%, 2.5 to 4%, 2.5 to 3.5%, 2.5 to 3%, 3 to 5%, 3 to 4.5%, 3 to 4%, 3 to 3.5%, 3.5 to 5%, 3.5 to 4.5%, 3.5 to 4%, 4 to 5%, 4 to 4.5%, or 4.5 to 5%. All ppms and percentages are by weight.

In an embodiment of the third aspect the method comprises preparing a beverage composition comprising sucrose in an amount from 0.5 to 3 wt %, and Reb M in an amount from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 pm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm.

In an embodiment of the third aspect the method comprises preparing a beverage composition comprising sucrose in an amount from 1.5 to 2.5 wt %, and Reb M in an amount from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm.

In an embodiment of the third aspect the method comprises preparing a beverage comprising a Brix ratio of Reb M:sucrose from 10:1 to 1:1, 9:1 to 1:1, 8:1 to 1:1, 7:1 to 1:1, 6:1 to 1:1, 5:1 to 1:1, 4:1 to 1:1, 3:1 to 1:1, 2:1 to 1:1, 10:1 to 2:1, 9:1 to 2:1, 8:1 to 2:1, 7:1 to 2:1, 6:1 to 2:1, 5:1 to 2:1, 4:1 to 2:1, 3:1 to 2:1, 10:1 to 3:1, 9:1 to 3:1, 8:1 to 3:1, 7:1 to 3:1, 6:1 to 3:1, 5:1 to 3:1, 6:1 to 3:1, 5:1 to 3:1, or 4:1 to 3:1.

In an embodiment of the third aspect the method comprises preparing a beverage composition comprising Reb M in a concentration from 200 ppm to 500 ppm, 250 ppm to 500 ppm, or 300 ppm to 500 ppm, and sucrose in an amount from 0.5 to 3 wt %, 0.5 to 2.5 wt %, 0.5 to 2 wt % wherein the Brix ratio of Reb M:sucrose is from 6:1 to 1:1, 5:1 to 2:1, or 4:1 to 3:1. In a preferred embodiment the method comprises preparing a beverage comprising a Brix ratio of Reb M:sucrose of about 4:1.

The data presented herein demonstrates that it is possible to reduce or minimize the sweetness linger effect, which results from using Reb M in a beverage, by adding HFCS to the beverage. The resulting beverage, which has a combination of Reb M and HFCS, has a reduced sweetness linger when compared to a beverage comprising Reb M alone. A fourth aspect of the invention is a method of reducing the sweetness linger of Reb M in a beverage, wherein the method comprises adding HFCS to the beverage in an amount from 2 to 8 wt %, wherein the Brix ratio or Reb M:HFCS is from 10:1 to 1:1.

In an embodiment of the fourth aspect the method comprises preparing a beverage comprising Reb M in a concentration from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm and HFCS in an amount from 2 to 8%, 2 to 7.5%, 2 to 7%, 2 to 6.5%, 2 to 6%, 2 to 5.5%, 2 to 5%, 2 to 4.5%, 2 to 4%, 2 to 3.5%, 2 to 3%, 2 to 2.5%, 2.25 to 8%, 2.25 to 7.5%, 2.25 to 7%, 2.25 to 6.5%, 2.25 to 6%, 2.25 to 5.5%, 2.25 to 5%, 2.25 to 4.5%, 2.25 to 4%, 2.25 to 3.5%, 2.25 to 3%, 2.25 to 2.5%, 2.5 to 8%, 2.5 to 7.5%, 2.5 to 7%, 2.5 to 6.5%, 2.5 to 6%, 2.5 to 5.5%, 2.5 to 5%, 2.5 to 4.5%, 2.5 to 4%, 2.5 to 3.5%, 2.5 to 3%, 3 to 8%, 3 to 7.5%, 3 to 7%, 3 to 6.5%, 3 to 6%, 3 to 5.5%, 3 to 5%, 3 to 4.5%, 3 to 4%, 3 to 3.5%, 3.5 to 8%, 3.5 to 7.5%, 3.5 to 7%, 3.5 to 6.5%, 3.5 to 6%, 3.5 to 5.5%, 3.5 to 5%, 3.5 to 4.5%, 3.5 to 4%, 4 to 8%, 4 to 7.5%, 4 to 7%, 4 to 6.5%, 4 to 6%, 4 to 5.5%, 4 to 5%, 4 to 4.5%, 4.5 to 8%, 4.5 to 7.5%, 4.5 to 7%, 4.5 to 6.5%, 4.5 to 6%, 4.5 to 5.5%, 4.5 to 5%, 5 to 8%, 5 to 7.5%, 5 to 7%, 5 to 6.5%, 5 to 6%, 5 to 5.5%, 5.5 to 8%, 5.5 to 7.5%, 5.5 to 7%, 5.5 to 6.5%, 5.5 to 6%, 6 to 8%, 6 to 7.5%, 6 to 7%, 6 to 6.5%, 6.5 to 8%, 6.5 to 7.5%, 6.5 to 7%, 6.62 to 8%, 6.62 to 7.5%, 6.62 to 7%, 7 to 8%, or 7 to 7.5%. All ppms and percentages are by weight.

In an embodiment of the fourth aspect the method comprises preparing a beverage composition comprising HFCS in an amount from 3 to 8 wt %, and Reb M in an amount from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm.

In an embodiment of the fourth aspect the method comprises preparing a beverage composition comprising HFCS in an amount from 4 to 8 wt %, and Reb M in an amount from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm.

In an embodiment of the fourth aspect the method comprises preparing a beverage comprising HFCS in an amount from 5 to 8 wt %, and Reb M in an amount from 100 ppm to 600 ppm, 150 ppm to 600 ppm, 200 ppm to 600 ppm, 250 ppm to 600 ppm, 300 ppm to 600 ppm, 350 ppm to 600 ppm, 400 ppm to 600 ppm, 450 ppm to 600 ppm, 500 ppm to 600 ppm, 550 ppm to 600 ppm, 100 ppm to 500 ppm, 150 ppm to 500 ppm, 200 ppm to 500 ppm, 250 ppm to 500 ppm, 300 ppm to 500 pp, 350 ppm to 500 ppm, 400 ppm to 500 ppm, 450 ppm to 500 ppm, 100 ppm to 400 ppm, 150 ppm to 400 ppm, 200 ppm to 400 ppm, 250 ppm to 400 ppm, 300 ppm to 400 ppm, 350 ppm to 400 ppm, 100 ppm to 300 ppm, 150 ppm to 300 ppm, 200 ppm to 300 ppm, 250 ppm to 300 ppm, 100 ppm to 250 ppm, 150 ppm to 200 ppm, or 200 ppm to 250 ppm.

In an embodiment of the fourth aspect the method comprises preparing a beverage comprising a Brix ratio of Reb M:HFCS from 10:1 to 1:1, 9:1 to 1:1, 8:1 to 1:1, 7:1 to 1:1, 6:1 to 1:1, 5:1 to 1:1, 4:1 to 1:1, 3:1 to 1:1, 2:1 to 1:1, 10:1 to 2:1, 9:1 to 2:1, 8:1 to 2:1, 7:1 to 2:1, 6:1 to 2:1, 5:1 to 2:1, 4:1 to 2:1, 3:1 to 2:1, 10:1 to 3:1, 9:1 to 3:1, 8:1 to 3:1, 7:1 to 3:1, 6:1 to 3:1, 5:1 to 3:1, 6:1 to 3:1, 5:1 to 3:1, or 4:1 to 3:1.

In an embodiment of the fourth aspect the method comprises preparing a beverage composition comprising Reb M in a concentration from 200 ppm to 500 ppm, 250 ppm to 500 ppm, or 300 ppm to 500 ppm, and HFCS in an amount from 4 to 7 wt %, 5 to 7 wt %, 6 to 7 wt % wherein the Brix ratio of Reb M:HFCS is from 6:1 to 1:1, 5:1 to 2:1, or 4:1 to 3:1. In a preferred embodiment the method comprises preparing a beverage comprising a Brix ratio of Reb M:HFCS of about 1:1

The method according to the third or fourth aspects of the present invention may comprise preparing a beverage composition with a pH from pH 2 to 5, pH 2.2 to 5, pH 2.4 to 5, pH 2.6 to 5, pH 2.8 to 5, pH 3.0 to 5, pH 3.5 to 5, pH 2 to 4.5, pH 2.2 to 4.5, pH 2.4 to 4.5, pH 2.6 to 4.5, pH 2.8 to 4.5, pH 3 to 4.5, pH 3.5 to 4.5, pH 2 to 4, pH 2.2 to 4, pH 2.4 to 4, pH 2.6 to 4, pH 2.8 to 4, pH 3 to 4, pH 3.5 to 4, pH 2 to 3.5, pH 2.2 to 3.5, pH 2.4 to 3.5, pH 2.6 to 3.5, pH 2.8 to 3.5, pH 3.0 to 3.5. Preferably the pH is in the range from pH 2.5 to 3.5.

The method according to the third or fourth aspects of the invention may comprise preparing a carbonated beverage composition. The gas pressure may be from 1.0-3.5 kg/m³. Preferably the CO₂ is at a gas pressure from 1.5-3.0 kg/m³, more preferably the CO₂ is at a gas pressure from 2.0-3.0 kg/m³.

In the method according to another embodiment of the third or fourth aspect of the invention, the gas pressure may be from 1.0-3.5 kgf/cm². Preferably the CO₂ is at a gas pressure from 1.5-3.0 kgf/cm², more preferably the CO₂ is at a gas pressure from 2.0-3.0 kgf/cm².

The method according to the third or fourth aspects of the invention may comprise preparing the beverage composition with any of the additional sweetening agents that have been listed above according to the first aspect of the invention.

The method according to the third or fourth aspects of the invention may comprise preparing the beverage composition with the addition of a buffer system, as described hereinbefore.

### EXAMPLES

### Experimental Protocol

Experiments were performed to determine the effect of combining different sweeteners with Reb M on the sweetness linger of the Reb M. Reb M was combined with sucrose, HFCS and sucralose in varying amounts.

The following samples were prepared;
Reb M 500 ppm (0.05 wt %) at pH 2.52 (phosphoric acid/phosphate buffer)
Reb M 400 ppm (0.04 wt %)+2 wt % sucrose at pH 2.52
Reb M 250 ppm (0.025 wt %)+5 wt % sucrose at pH 2.52
Reb M 400 ppm (0.04 wt %)+2.65 wt % HFCS at pH 2.52
Reb M 250 ppm (0.025 wt %)+6.62 wt % HFCS at pH 2.52
Reb M 400 ppm (0.04 wt %)+0.005 wt % sucralose at pH 2.52
Reb M 300 ppm (0.03 wt %)+0.01 wt % sucralose at pH 2.52
Reb M 200 ppm (0.02 wt %)+0.015 wt % sucralose at pH 2.52
Reb M 100 ppm (0.01 wt %)+0.02 wt % sucralose at pH 2.52

All samples were designed to be equi-sweet with a Brix of 10° Bx.

The samples were evaluated by a trained sensory profiling panel comprising approximately 10 panelists, experienced in evaluating soft drinks completed the work. Panelists attended 2 training sessions to familiarise themselves with the sweetness characteristics of the products under test, to establish approximate sweetness scaling and to practice the evaluation protocol.

Samples were blind tested and presented with a 3 digit code, according to a balanced experimental design. All panel members evaluated all samples and replicates in a different order, which minimised bias and flavour carry over effects.

Six samples were evaluated over a 90 minute session with a 5 minute break between samples. During the break panellists were instructed to cleanse their palate by eating an unsalted cracker and drinking mineral water. 3 replicates of each sample will be carried out over 5×90 minute sessions.

Panelists carried out all evaluations in individual sensory booths, inputting data into via computer using RedJade software. For each solution, panelists rated sweetness on an unstructured line scale anchored at each end by nil to extreme. Sweetness ratings took place 10 seconds after taking their first sip and then 10 seconds after taking a second sip; and then 30 seconds, 1 minute, 2 minutes, 3 minutes 4 minutes and 5 minutes later.

Samples were blind tested and presented with a 3 digit code, according to a balanced experimental design. All panel members evaluated all samples and replicates in a different order, which minimised bias and flavour carry over effects.

The sweetness intensity was plotted against time, to allow the decline in sweetness can be compared across all samples. The data was analysed using Analysis of Variance and multiple comparison tests at each time point to identify when sweetness intensity discriminates across the sample set and between specific samples.

Results

The Reb M standard solution shows a strong lingering aftertaste after 5 minutes.

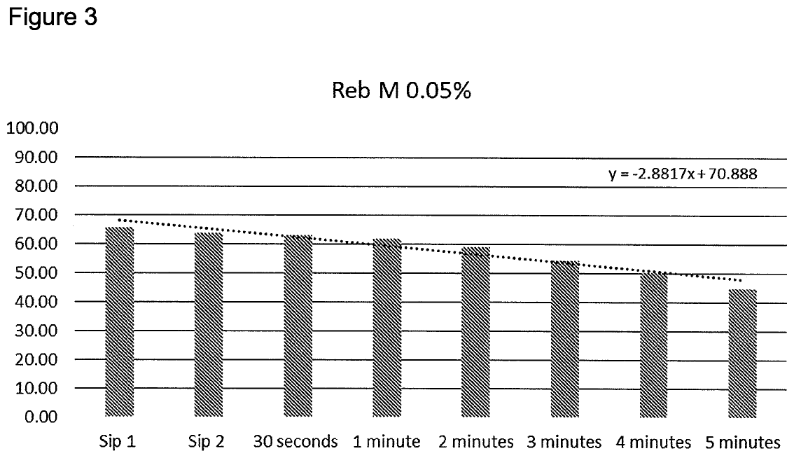

This indicates that despite a significant drop in sweetness after one minute, and further drops after 3 and 5 minutes, the sweetness is not falling fast enough to be appropriate for use in drink products. The equation displayed in FIG. 3 shows the gradient of the trendline (−2.8817) and indicates the rate of aftertaste decrease for the sample. The gradient was used as an objective measure allowing comparison of the samples. A larger integer suggests a faster rate of decline in the sweetness linger.

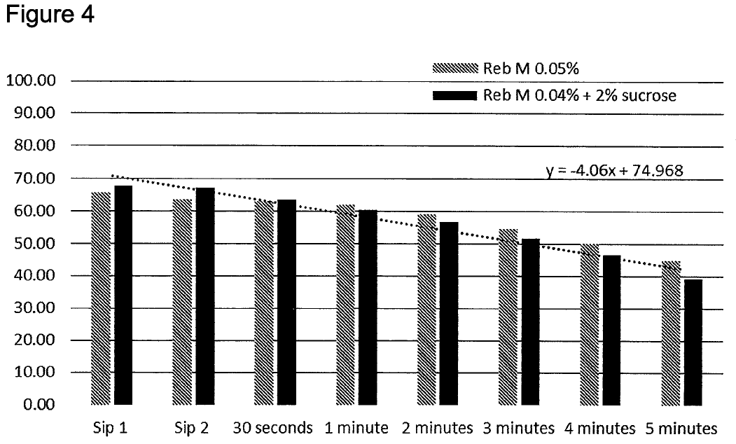

When 2 wt % sucrose was added to the Reb M, the aftertaste dissipates faster and is weaker after 5 minutes. FIG. 4 shows a statistically significant drop in sweet aftertaste after one minute, again after 3 minutes and finally after 5 minutes. These breaks in the significance groupings are the same as seen for Reb M alone. The difference between the results is highlighted in the equation displayed on the chart. The gradient of the line for the Reb M+2 wt % sucrose sample is measured at −4.06, showing a far steeper drop than for Reb M alone (−2.8817). This indicates that the presence of sucrose masks the sweetness linger of Reb M.

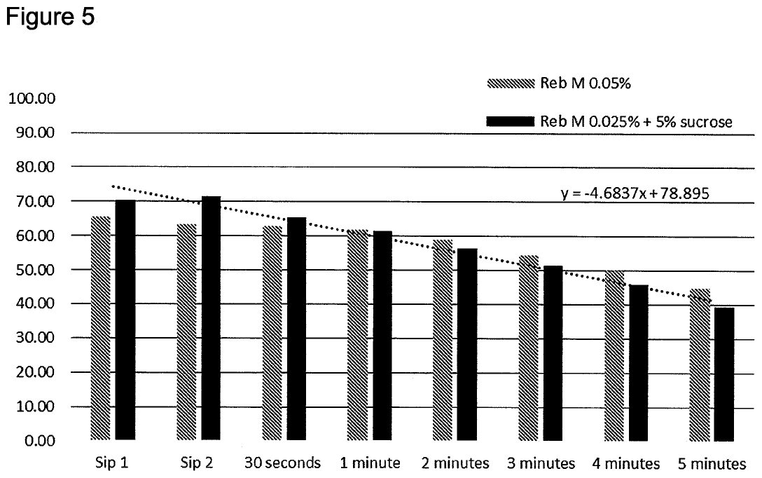

A higher concentration sucrose sample was also investigated this is shown in FIG. 5. When 5 wt % sucrose was combined with Reb M the sweetness linger effect was reduced more than with 2% sucrose present. However, surprisingly, the difference between the 2 wt % sucrose and 5 wt % sucrose samples is minimal. The gradient with 2 wt % sucrose is −4.06 and 5% is −4.6837. This indicates that the reduction in sweetness is not directly concentration dependent. As such there is an optimal balance that can be achieved between the efficacy of sucrose in reducing the sweetness linger and a reduction in the caloric impact of the sucrose.

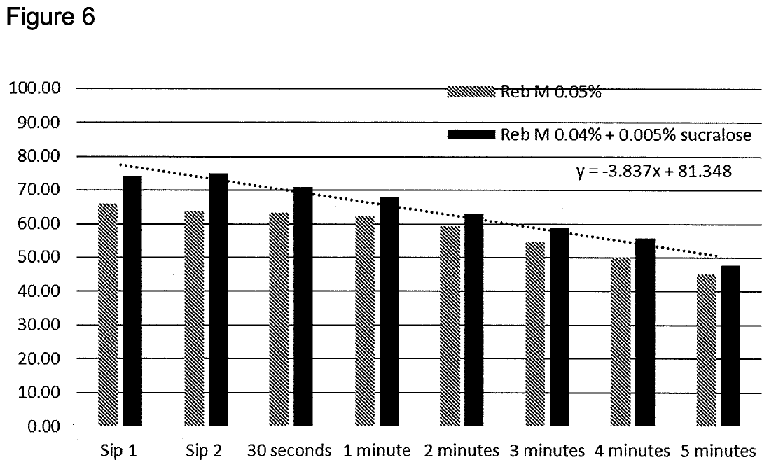

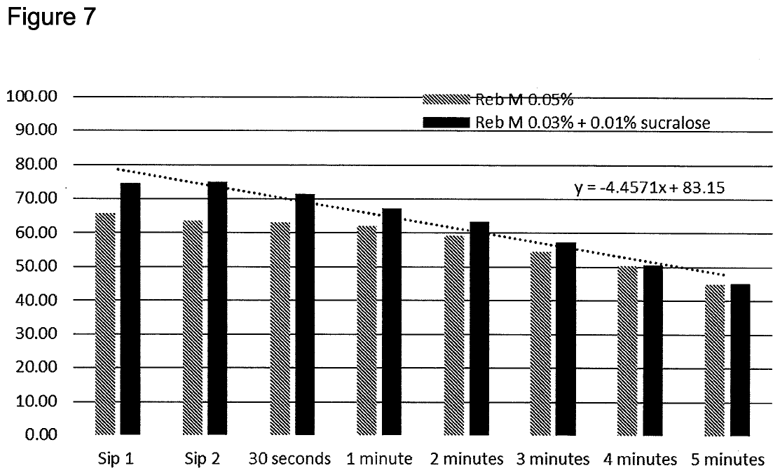

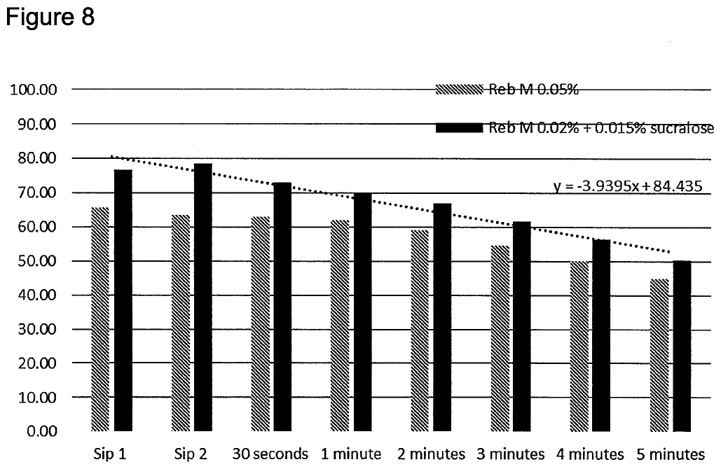

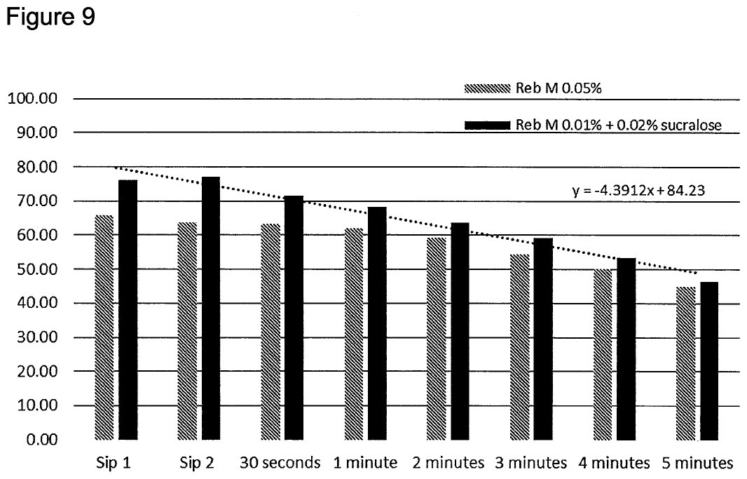

The effect of the addition of sucralose is shown in FIGS. 6 to 9. Adding sucralose to the Reb M solution does increase the rate at which the sweetness linger fades, as indicated by the higher gradient values for all the +sucralose samples. However, this effect is lessened as the sweetness increases during consumption of the samples with sucralose, peaking on Sip 2. This results in all of the +sucralose samples having either a higher sweetness level or the same sweetness level compared to Reb M alone, after the 5 minute evaluation.

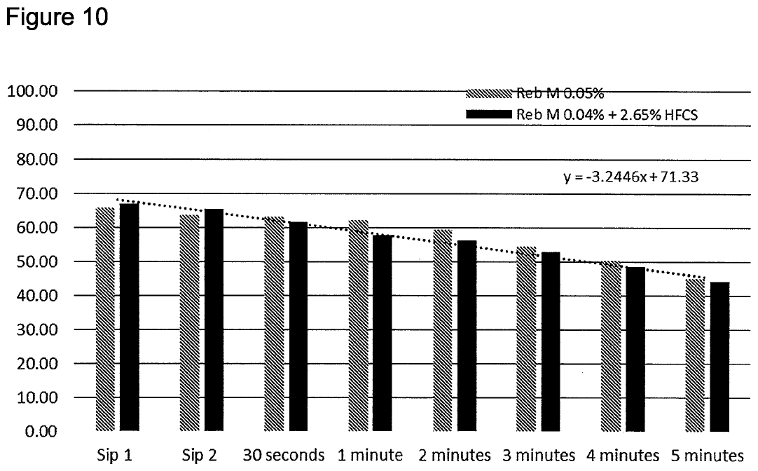

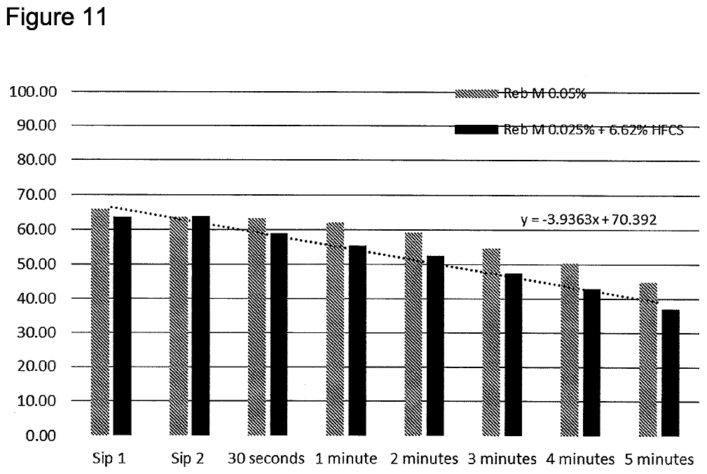

The effect of the addition of HFCS is shown in FIGS. 10 and 11. The addition of 2.65 wt % HFCS has a small effect on reducing the sweetness linger of Reb M after 5 minutes with a gradient of −3.244 compared to −2.8817 of Reb M alone. However, at the one minute and two minute time points the reduction is more pronounced. When a high amount of HFCS (6.62 wt %) is used the gradient is increased and the reduction in sweetness linger at 5 minutes is also increased (shown in FIG. 11). This indicates that HFCS can be used to effectively mask the sweetness linger of Reb M.

Table 1 summarizes the overall sweetness drop and rate of sweetness decrease for all samples.

| | Overall | Significant | Rate of Decrease |
|---|---|---|---|
| | Sweetness | Difference | (gradient of |
| Sample | Drop | Perceived | trendline) |
| Reb M 0.05% | 20.9 | After 3 | -2.8817 |
| | | minutes, then | |
| | | 5 minutes | |
| Reb M 0.04% + | 28.6 | After 1 minute, | -4.06 |
| 2% Sucrose | | then 3 minutes, | |
| | | then 5 minutes | |
| Reb M 0.025% + | 31.1 | After 1 minute, | -4.6837 |
| 5% Sucrose | | then 3 minutes, | |
| | | then 5 minutes | |
| Reb M 0.04% + | 26.4 | After 2 minutes, | -3.837 |
| 0.005% | | then 5 minutes | |
| Sucralose | | | |
| Reb M 0.03% + | 29.5 | After 2 minutes, | -4.4571 |
| 0.01% Sucralose | | then 4 minutes | |
| Reb M 0.02% + | 26.3 | After 1 minute, | -3.9395 |
| 0.015% | | then 3 minutes, | |
| Sucralose | | then 5 minutes | |
| Reb M 0.01% + | 29.8 | After 1 minute, | -4.3912 |
| 0.02% Sucralose | | then 2 minutes, | |
| | | then 4 minutes | |
| Reb M 0.04% + | 22.9 | After 1 minute, | -3.2446 |
| 2.65% HFCS | | then 4 minutes | |
| Reb M 0.025% + | 26.9 | After 1 minute, | -3.9363 |
| 6.62% HFCS | | then 3 minutes, | |
| | | then 5 minutes | |

All ppms and percentages are by weight.

In summary combining Reb M with either sucrose or HFCS was seen to reduce the sweetness lingering effect of the Reb M. The combination with sucrose had the additional benefit that a small concentration of sucrose could be used to significantly reduce the sweetness linger of Reb M. Therefore this combination could be effectively used to reduce sweetness linger whilst also maintaining a low calorie beverage.

Combination with sucralose increased the sweetness intensity on the second sip and the sweetness intensity remained higher throughout the 5 minutes than the Reb M sample alone, therefore the addition of sucralose did not reduce the sweetness linger of the Reb M.

1. A beverage composition comprising Reb M in a concentration from 100 ppm to 600 ppm and sucrose in an amount from 0.5 to 5 wt %, wherein the Brix ratio of Reb M:sucrose is from 10:1 to 1:1.

2. The beverage composition of claim 1, wherein the sucrose is present in a concentration from 0.5 to 3 wt %.

3. The beverage composition of claim 2, wherein the Brix ratio of Reb M:sucrose is from 5:1 to 1:1.

4. A beverage composition comprising Reb M in a concentration from 100 ppm to 600 ppm and HFCS in an amount from 2 to 8 wt %, wherein the Brix ratio of Reb M:HFCS is from 10:1 to 1:1.

5. The beverage composition of claim 4, wherein the HFCS is present in a concentration from 3 to 7 wt %.

6. The beverage composition of claim 4, wherein the Brix ratio of Reb M:HFCS is from 5:1 to 1:1.

7. The beverage composition of claim 1, wherein the Reb M is present in a concentration from 200 ppm to 600 ppm.

8. The beverage composition of claim 1, wherein the Reb M is present in a concentration from 300 ppm to 600 ppm.

9. The beverage composition of claim 1, wherein the Reb M is present in a concentration from 400 ppm to 600 ppm.

10. The beverage composition of claim 1, wherein the beverage comprises carbon dioxide gas at a gas pressure of 1.0-3.5 kgf/cm².

11. The beverage composition of claim 1, having a pH in the range of 2.0 to 3.0.

12. The beverage composition of claim 1, further comprising a sweetener selected from the group consisting of Reb A, Reb B, Reb C, Reb D, Reb E, stevioside, mogroside V, sucrose, HCFS, aspartame, saccharine, acesulfame K, erythritol and combinations thereof.

13. The beverage composition of claim 1, further comprising caffeine, cinnamaldehyde, phosphoric acid or caramel coloring.

14. The beverage composition of claim 1, wherein the total sweetness of the beverage is to 5 to 15 degrees Brix.

15. A method of reducing the sweetness linger of Reb M in a beverage, wherein the method comprises adding sucrose to the beverage in an amount from 0.5 to 5 wt %, wherein the Brix ratio or Reb M:sucrose is from 10:1 to 1:1.

16. The method of claim 15, wherein the sucrose is present in a concentration from 0.5 to 3 wt %.

17. The method of claim 15, wherein the Brix ratio of Reb M:sucrose is from 5:1 to 1:1.

18-24. (canceled)

25. The method of claim 15, wherein the beverage has a pH in the range of 2.0 to 3.0.

26. The method of claim 15, wherein the beverage also comprises a sweetener selected from the group consisting of Reb A, Reb B, Reb C, Reb D, Reb E, stevioside, mogroside V, sucrose, HCFS, aspartame, saccharine, acesulfame K, erythritol and combinations thereof.

27. The method of claim 15, wherein the beverage also comprises caffeine, cinnamaldehyde, phosphoric acid or caramel coloring.
